(19) United States
(12) Patent Application Publication
(10) Pub. No.: US 2014/0168031 A1
(43) Pub. Date: Jun. 19, 2014

(54) HOST COMPUTER AND METHOD OF SETTING DUAL MONITORS, KEYBOARDS AND MICE FOR THE HOST COMPUTER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: ZHENG-QUAN PENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/102,645

(22) Filed: Dec. 11, 2013

(30) Foreign Application Priority Data
Dec. 17, 2012 (CN) 2012105480877

(51) Int. Cl. G09G 5/14; G06F 3/14

(52) U.S. Cl. CPC G09G 5/14; G06F 3/1431
USPC 345/1.1

(57) ABSTRACT

In a method for setting dual monitors for a host computer, when a host computer connects to two monitor, two keywords, and two mice, the host computer is controlled to work in a dual-monitor mode. A main monitor and a subordinate monitor are set from the monitors that are connected to the host computer, and a main keyboard/mouse and a subordinate keyboard/mouse are set from the keyboards and mice that are connected to the host computer. The main keyboard and mouse and linked to the main monitor, and the subordinate keyboard and mouse are linked to the subordinate monitor.

### BACKGROUND

1. Technical Field

Embodiments of the present disclosure relate to a hardware configuration setup of a computer system, and more specifically to a host computer and a method of setting dual monitors for the host computer.

2. Description of Related Art

Dual monitors are often used to view large workspaces, share presentations, and many other reasons. However, it is not always easy to set up dual monitors. Thus, there is room for improvement in the art.

### BRIEF DESCRIPTION OF THE DRAWINGS

FIG. 1 is a schematic diagram of one embodiment of a hardware configuration of a computer system.

FIG. 2 is a block diagram of one embodiment of a host computer of the computer system of FIG. 1.

FIG. 3 is a flowchart of one embodiment of a method of setting dual monitors for the host computer of FIG. 2.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

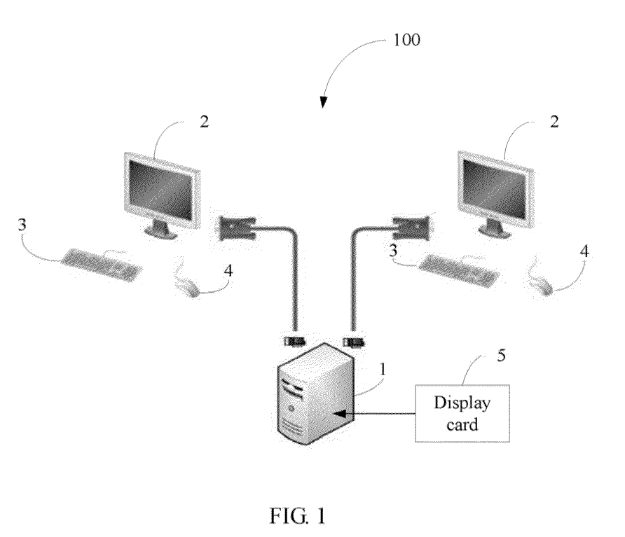

FIG. 1 is a schematic diagram of one embodiment of a hardware configuration of a computer system 100. The computer system 100 comprises a host computer 1, two monitors 2, two keyboards 3, and two mice 4. The monitors 2, the keyboards 3, and the mice 4 are connected electronically to the host computer 1. The host computer 1 has one or more display cards 5 installed. The host computer 1 can be, but is not limited to be, a personal computer, a server computer, or a workstation computer.

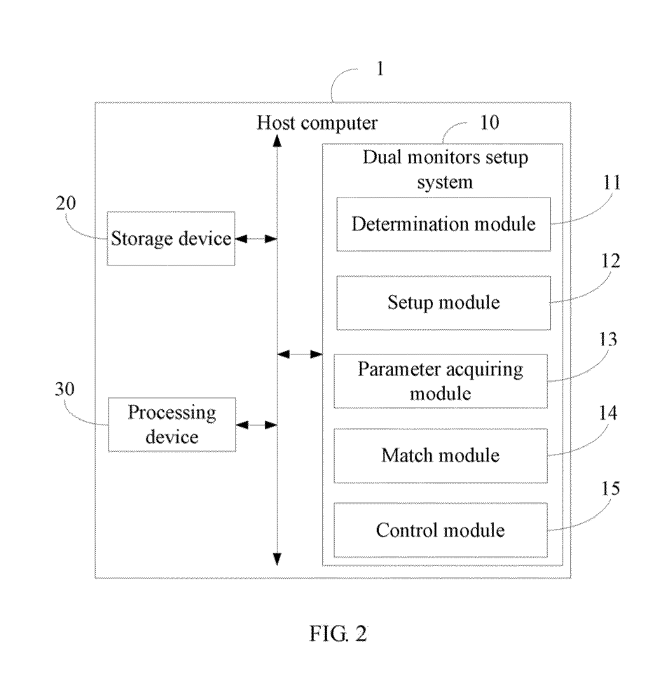

Referring to FIG. 2, the host computer 1 comprises a dual monitors setup system 10, a storage device 20, and a processing device 30.

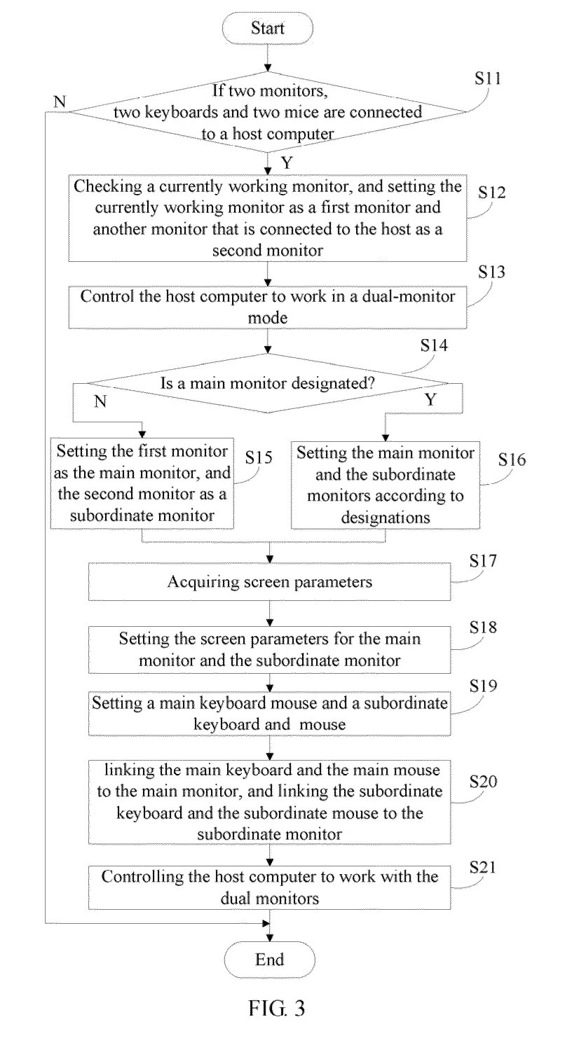

The dual monitors setup system 10 comprises a number of function modules, such as a determination module 11, a setup module 12, a parameter acquiring module 13, a match module 14, and a control module 15. The function modules 11-15 can include computerized codes in the form of one or more computer-readable programs that are stored in a non-transitory computer-readable storage medium (e.g., the storage device 20) and executed by at least one processor (i.e., the processing device 30) of the host computer 1, and provide at least the functions needed to execute steps illustrated in FIG. 3 below.

The storage device 20 can comprise some type(s) of non-transitory computer-readable storage medium, such as a hard disk drive, a compact disc, a digital video disc, or a tape drive. The storage device 20 can be used to store the computerized codes of the function modules of the dual monitors setup system 10.

The processing device 30 can comprise a processor, a microprocessor, an application-specific integrated circuit (ASIC), and a field programmable gate array, (FPGA) for example. The processing device 30 can execute the computerized code of the function modules of the dual monitors setup system 10 to realize the functions of the dual monitors setup system 10.

FIG. 3 is a flowchart of one embodiment of a method of setting dual monitors for the host computer 1. The method is executed by the processing device 30 of the host computer 1. Depending on the embodiment, additional steps in FIG. 3 may be added, others removed, and the ordering of the steps may be changed.

In step S11, the determination module 11 determines if two monitor 2, two keyboard 3, and two mice 4 are connected to the host computer 1. When two monitor 2, two keyboard 3, and two mice 4 are connected to the host computer 1, step S12 is implemented. Otherwise, only one monitor, one keyboard, and/or one mouse are connected to the host computer 1, the procedure ends.

In step S12, the determination module 11 checks a currently working monitor 2, sets the currently working monitor 2 as a first monitor, and sets another monitor 2 that is connected to the host computer 1 as a second monitor.

In step S13, the determination module 11 controls the host computer 1 to work in a dual-monitor mode.

In step S14, the setup module 12 determines if a main monitor of the host computer 1 is designated from the monitors 2 that are connected to the host computer 1. In one embodiment, the setup module 12 outputs a user interface that includes a monitor list for a user to select a monitor from and set the selected monitor as the main monitor. When the main monitor of the host computer 1 is not designated, step S15 is implemented. Otherwise, when the main monitor of the host computer 1 is designated by the user, step S16 is implemented.

In step S15, the setup module 12 automatically sets the first monitor as the main monitor, and the second monitor as a subordinate monitor.

In step 516, the setup module 12 sets the designated monitor as the main monitor and another monitor as the subordinate monitor.

In step S17, the parameter acquiring module 13 acquires screen parameters from settings of the one or more display cards in the host computer 1. In one embodiment, the screen parameters comprise resolutions, colors, and refresh rates of the monitors 2.

In step S18, the parameter acquiring module 13 sets the screen parameters for the main monitor and the subordinate monitor.

In step S19, the setup module 12 sets a main keyboard, a main mouse, a subordinate keyboard, and a subordinate mouse. In one embodiment, the setup module 12 outputs a user interface that includes a keyboard-mouse list for a user to select a main keyboard and main mouse from and set the main keyboard and main mouse according to the selection. In other embodiments, the setup module 12 sets the main keyboard and main mouse arbitrarily.

In step S20, the match module 14 links the main keyboard and the main mouse to the main monitor, and links the subordinate keyboard and the subordinate mouse to the subordinate monitor.

In step S21, the control module 15 controls the host computer 1 to work in the dual-monitor mode.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A host computer, comprising:
one or more display cards and a dual monitors setup system, the dual monitors setup system comprising computerized program codes to:
determine whether more than one monitors, more than one keyboards and more than one mice are connected to the host computer;
control the host computer to work in a dual-monitor mode when more than one monitors, more than one keyboards and more than one mice are connected to the host computer;
set a main monitor and a subordinate monitor from the monitors that are connected to the host computer;
set a main keyboard, a main mouse and a subordinate keyboard and a subordinate mouse from the keyboards and mouse that are connected to the host computer;
link the main keyboard and the main mouse to the main monitor, and link the subordinate keyboard and the subordinate mouse to the subordinate monitor; and
control the host computer to work with the dual monitors.

2. The host computer according to claim 1, the computerized codes further:
check a currently working monitor, set the currently working monitor as a first monitor, and set another monitor that is connected to the host computer as a second monitor.

3. The host computer according to claim 2, wherein the first monitor is set as the main monitor, and the second monitor is set as the subordinate monitor.

4. The host computer according to claim 1, wherein the main keyboard mouse and the subordinate keyboards and mouse are set according to designations by a user.

5. The host computer according to claim 1, the computerized codes further:
acquire screen parameters from settings of the one or more display cards of the host computer, and set the screen parameters for the main monitor and the subordinate monitor.

6. A method of setting dual monitors of a host computer, comprising:
determine whether more than one monitors, more than one keyboards and more than one mice are connected to the host computer;
controlling the host computer to work in a dual-monitor mode when more than one monitors, more than one keyboards and more than one mice are connected to the host computers;
setting a main monitor and a subordinate monitor from the monitors that are connected to the host computer;
setting a main keyboard, a main mouse and a subordinate keyboard and a subordinate mouse from the keyboards and mouse that are connected to the host computer;
linking the main keyboard and the main mouse to the main monitor, and linking the subordinate keyboard and the subordinate mouse to the subordinate monitor; and
controlling the host computer to work with the dual monitors.

7. The method according to claim 6, further comprising:
checking a currently working monitor, setting the currently working monitor as a first monitor, and setting another monitor that connect to the host computer as a second monitor.

8. The method according to claim 7, wherein the first monitor is set as the main monitor, and the second monitor is set as the subordinate monitor.

9. The method according to claim 6, wherein the main keyboard mouse and the subordinate keyboard and mouse are set according to designations by a user.

10. The method according to claim 6, further comprising:
acquiring screen parameters from setting of one or more display cards of the host computer, and set the screen parameters for the main monitor and the subordinate monitor.

11. A non-transitory storage medium having stored thereon instructions that, when executed by processers of a host computer, causes the processers to perform a method of setting dual monitor for the host computer, wherein the method comprises:
Determining whether more than one monitors, more than one keyboards and more than one mice are connected to the host computer;
controlling the host computer to work in a dual-monitor mode when more than one monitors, more than one keyboards and more than one mice are connected to the host computer;
setting a main monitor and a subordinate monitor from the monitors that are connected to the host computer;
setting a main keyboard, a main mouse and a subordinate keyboard and a subordinate mouse from the keyboards and mouse that are connected to the host computer;
linking the main keyboard and the main mouse to the main monitor, and linking the subordinate keyboard and the subordinate mouse to the subordinate monitor; and
controlling the host computer to work with the dual monitors.

12. The non-transitory storage medium according to claim 11, wherein the method further comprises:
checking a currently working monitor, setting the currently working monitor as a first monitor, and setting another monitor that connect to the host computer as a second monitor.

13. The non-transitory storage medium according to claim 12, wherein the first monitor is set as the main monitor, and the second monitor is set as the subordinate monitor.

14. The non-transitory storage medium according to claim 11, wherein the main keyboard mouse and the subordinate keyboard and mouse are set according to designations by a user.

15. The non-transitory storage medium according to claim 11, wherein the method further comprises:
acquiring screen parameters from setting of one or more display cards of the host computer, and set the screen parameters for the main monitor and the subordinate monitor.
